(19) United States
(12) Patent Application Publication
(10) Pub. No.: US 2022/0295163 A1
(43) Pub. Date: Sep. 15, 2022

(54) NOTEBOOK COMPUTER

(71) Applicants: Inventec (Pudong) Technology Corp., Shanghai (CN); Inventec Corporation, Taipei (TW)

(72) Inventor: Kuo-Chi Ting, Taipei (TW)

(73) Assignees: Inventec (Pudong) Technology Corp., Shanghai (CN); Inventec Corporation, Taipei (TW)

(21) Appl. No.: 17/476,442

(22) Filed: Sep. 15, 2021

(30) Foreign Application Priority Data
Mar. 15, 2021 (CN) 202110275751.4

(51) Int. Cl. H04R 1/02; G06F 1/16

(52) U.S. Cl. CPC H04R 1/023; G06F 1/1616; G06F 1/1656; G06F 1/1688

(57) ABSTRACT

A notebook computer includes a base, a speaker module and a top cover. The base includes a keyboard frame and a bottom cover. The keyboard frame is disposed on the bottom cover. The speaker module includes a speaker cover and a speaker main body. The speaker cover is disposed on the bottom cover to form a resonance chamber between the speaker cover and the bottom cover. The speaker main body is disposed on the speaker cover and located in the resonance chamber. The top cover is pivotally connected to the base.

### BACKGROUND OF THE INVENTION

### 1. Field of the Invention

The invention relates to a notebook computer and, more particularly, to a notebook computer capable of improving vibration of a speaker and increasing internal space of the speaker.

### 2. Description of the Prior Art

In general, a base of a notebook computer consists of a keyboard frame and a bottom cover. At present, a speaker of the notebook computer is assembled into a casing first and then fastened or engaged with the keyboard frame. The thickness of the casing will occupy internal space of the speaker, such that the internal space of the speaker is reduced. Therefore, the speaker will be limited in the performance of the bass, thereby making the bass not deep enough. Furthermore, the casing of the speaker is usually covered with a rubber ring and directly placed on the keyboard frame. Accordingly, when the speaker emits sound, it is easy to cause the system to vibrate and generate abnormal sound.

### SUMMARY OF THE INVENTION

The invention provides a notebook computer capable of improving vibration of a speaker and increasing internal space of the speaker, so as to solve the aforesaid problems.

According to an embodiment of the invention, a notebook computer comprises a base, a speaker module and a top cover. The base comprises a keyboard frame and a bottom cover. The keyboard frame is disposed on the bottom cover. The speaker module comprises a speaker cover and a speaker main body. The speaker cover is disposed on the bottom cover to form a resonance chamber between the speaker cover and the bottom cover. The speaker main body is disposed on the speaker cover and located in the resonance chamber. The top cover is pivotally connected to the base.

In another embodiment, the speaker module further comprises a vibration absorbing structure disposed between the speaker cover and the bottom cover.

As mentioned in the above, the invention directly disposes the speaker cover on the bottom cover to form the resonance chamber between the speaker cover and the bottom cover. In other words, an opening of the speaker cover is blocked by the bottom cover, such that there is no need to add additional cover plate. The internal space of the speaker can be effectively increased (i.e. the resonance chamber can be enlarged) without the thickness of the cover plate. Accordingly, the bass of the speaker can have better response. Furthermore, since the speaker cover is disposed on the bottom cover instead of being disposed on the keyboard frame, the vibration generated when the speaker emits sound is not directly transmitted to the keyboard frame, such that the keyboard frame is affected by less vibration and is not easy to generate abnormal sound. Moreover, the invention may dispose the vibration absorbing structure between the speaker cover and the bottom cover, so as to utilize the vibration absorbing structure to absorb the vibration generated when the speaker emits sound, thereby further reducing the abnormal sound generated by the notebook computer due to the vibration of the speaker.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a notebook computer according to an embodiment of the invention.

FIG. 2 is a schematic view illustrating a cross-section of a base shown in FIG. 1.

FIG. 3 is a schematic view illustrating a cross-section of a base according to another embodiment of the invention.

FIG. 4 is a schematic view illustrating a cross-section of a base according to another embodiment of the invention.

FIG. 5 is a schematic view illustrating a cross-section of a base according to another embodiment of the invention.

### DETAILED DESCRIPTION

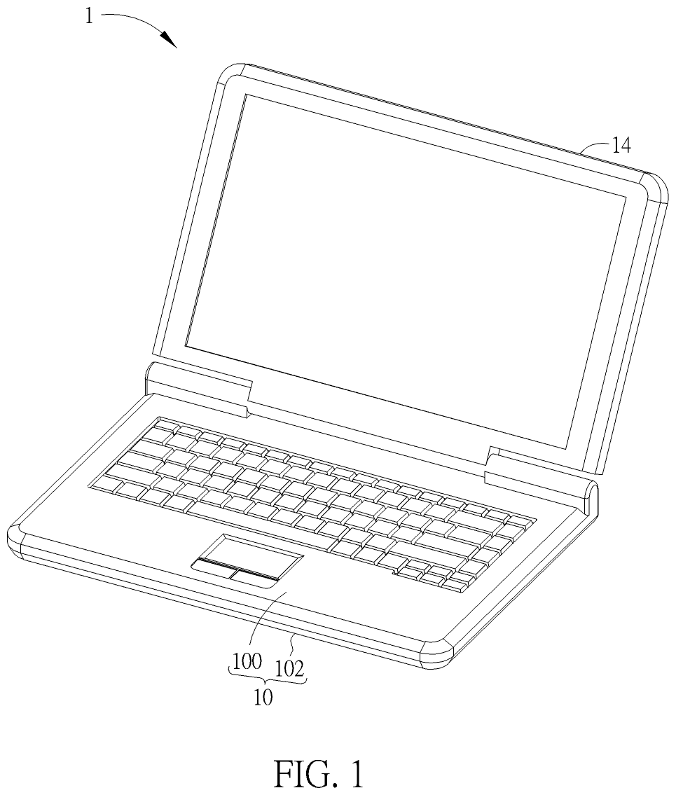

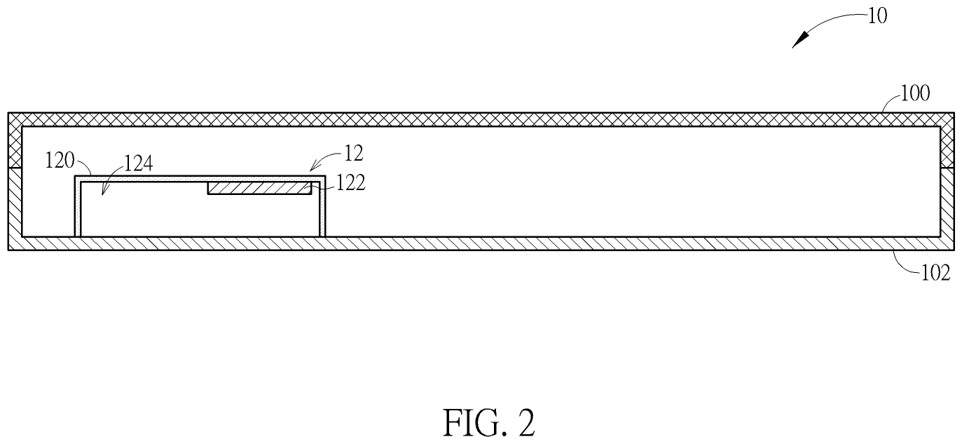

Referring to FIGS. 1 and 2, FIG. 1 is a schematic view illustrating a notebook computer 1 according to an embodiment of the invention and FIG. 2 is a schematic view illustrating a cross-section of a base 10 shown in FIG. 1.

As shown in FIGS. 1 and 2, a notebook computer 1 comprises a base 10, a speaker module 12 and a top cover 14. In general, the notebook computer 1 may be further equipped with some necessary hardware or software components for specific purposes, such as processor, display, circuit board, memory, power supply, applications, communication module, etc., and it depends on practical applications. The base 10 comprises a keyboard frame 100 and a bottom cover 102. The keyboard frame 100 is disposed on the bottom cover 102 to form the base 10. In practical applications, the keyboard frame 100 is used to install a keyboard. A user may lean his/her wrist on a hand rest area of the keyboard frame 100 to operate the keyboard. The top cover 14 is pivotally connected to the base 10. In general, the top cover 14 may be pivotally connected to the base 10 by a hinge or other rotating shafts, such that the top cover 14 may be closed or opened with respect to the base 10.

The speaker module 12 comprises a speaker cover 120 and a speaker main body 122. The speaker cover 120 is disposed on the bottom cover 102 of the base 10 to form a resonance chamber 124 between the speaker cover 120 and the bottom cover 102. In this embodiment, the speaker cover 120 may be adhered to the bottom cover 102 of the base 10 to seal a gap between the speaker cover 120 and the bottom cover 102 to avoid air leakage. Needless to say, the speaker cover 120 may also be fastened to the bottom cover 102 of the base 10 by screws or engaging structures. The speaker main body 122 is disposed on the speaker cover 120 and located in the resonance chamber 124. The speaker main body 122 is used to emit sound.

As shown in FIG. 2, an opening of the speaker cover 120 is blocked by the bottom cover 102 of the base 10, such that there is no need to add additional cover plate. The internal space of the speaker can be effectively increased (i.e. the resonance chamber 124 can be enlarged) without the thickness of the cover plate. Accordingly, the bass of the speaker can have better response. Furthermore, since the speaker cover 120 is disposed on the bottom cover 102 of the base 10 instead of being disposed on the keyboard frame 100, the vibration generated when the speaker emits sound is not directly transmitted to the keyboard frame 100, such that the keyboard frame 100 is affected by less vibration and is not easy to generate abnormal sound.

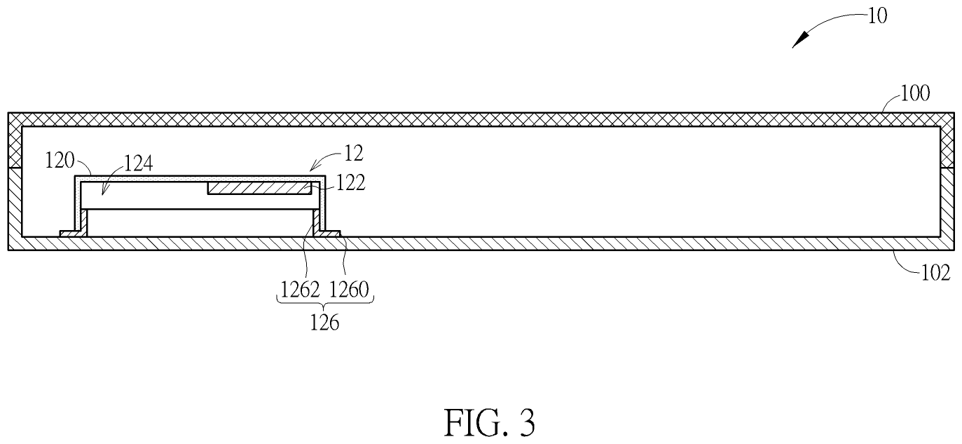

Referring to FIG. 3, FIG. 3 is a schematic view illustrating a cross-section of a base 10 according to another embodiment of the invention. As shown in FIG. 3, the speaker module 12 may further comprise a vibration absorbing structure 126. The vibration absorbing structure 126 is disposed between the speaker cover 120 and the bottom cover 102 of the base 10. The vibration absorbing structure 126 is ring-shaped and a shape of the vibration absorbing structure 126 is identical to a shape of the opening of the speaker cover 120. In this embodiment, the speaker cover 120 may be adhered to the vibration absorbing structure 126 and the vibration absorbing structure 126 may be adhered to the bottom cover 102, such that the speaker cover 120 is disposed on the bottom cover 102 of the base 10 to form the resonance chamber 124 between the speaker cover 120 and the bottom cover 102.

In this embodiment, the vibration absorbing structure 126 may comprise a flange 1260 and a side wall 1262, wherein the flange 1260 extends outward from a bottom of the side wall 1262. When the speaker cover 120 is adhered to the vibrating absorbing structure 126, a lower edge of the speaker cover 120 abuts against the flange 1260 and an inner wall of the speaker cover 120 abuts against the side wall 1262. Then, when the vibrating absorbing structure 126 is adhered to the bottom cover 102 of the base 10, the vibration absorbing structure 126 seals a gap between the speaker cover 120 and the bottom cover 102 to avoid air leakage. In this embodiment, the vibration absorbing structure 126 may be a sponge or other vibration absorbing materials according to practical applications. The vibration absorbing structure 126 can absorb the vibration generated when the speaker emits sound, thereby further reducing the abnormal sound generated by the notebook computer due to the vibration of the speaker.

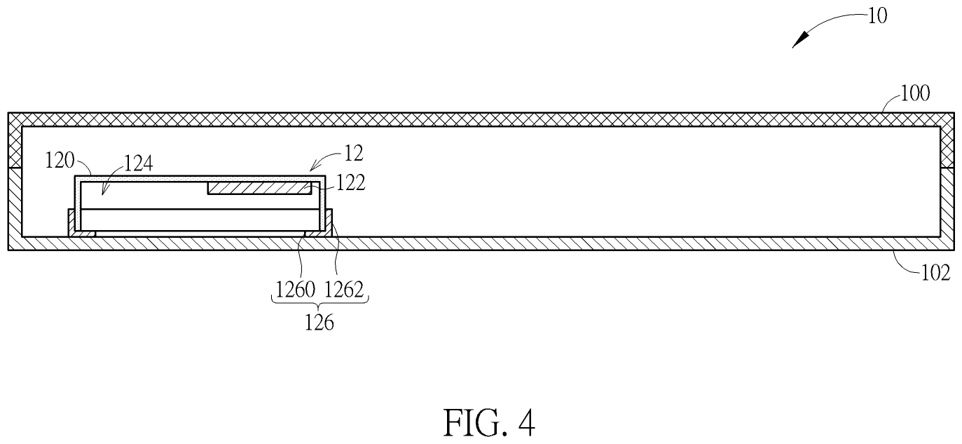

Referring to FIG. 4, FIG. 4 is a schematic view illustrating a cross-section of a base 10 according to another embodiment of the invention. As shown in FIG. 4, the vibration absorbing structure 126 comprises a flange 1260 and a side wall 1262. Compared to the embodiment shown in FIG. 3, the difference is that the flange 1260 of the vibration absorbing structure 126 extends inward from a bottom of the side wall 1262. Therefore, when the speaker cover 120 is adhered to the vibrating absorbing structure 126, a lower edge of the speaker cover 120 abuts against the flange 1260 and an outer wall of the speaker cover 120 abuts against the side wall 1262. It should be noted that the principle of the vibrating absorbing structure 126 has been mentioned in the above, so the repeated explanation will not be depicted herein again.

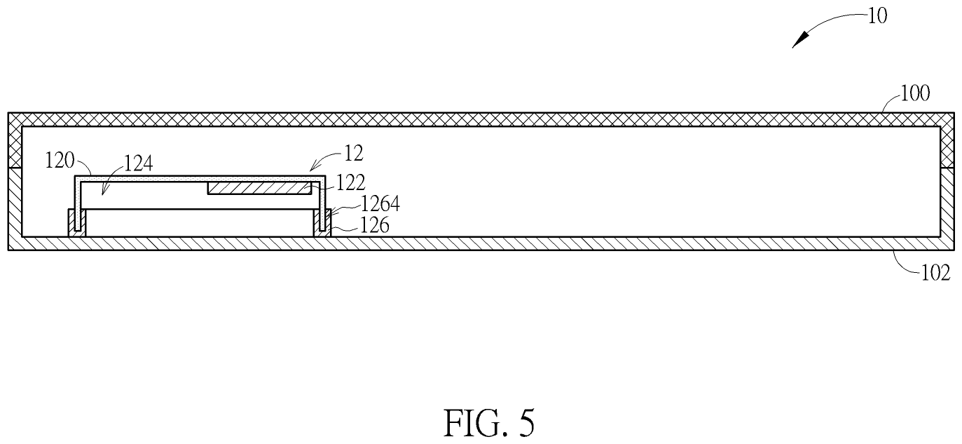

Referring to FIG. 5, FIG. 5 is a schematic view illustrating a cross-section of a base 10 according to another embodiment of the invention. As shown in FIG. 5, the vibration absorbing structure 126 comprises a U-shaped recess 1264, wherein the U-shaped recess 1264 surrounds the vibration absorbing structure 126. Thus, in this embodiment, a lower edge of the speaker cover 120 may be inserted into the U-shaped recess 1264 to fasten the speaker cover 120 on the vibration absorbing structure 126. It should be noted that the principle of the vibrating absorbing structure 126 has been mentioned in the above, so the repeated explanation will not be depicted herein again.

As mentioned in the above, the invention directly disposes the speaker cover on the bottom cover to form the resonance chamber between the speaker cover and the bottom cover. In other words, an opening of the speaker cover is blocked by the bottom cover, such that there is no need to add additional cover plate. The internal space of the speaker can be effectively increased (i.e. the resonance chamber can be enlarged) without the thickness of the cover plate. Accordingly, the bass of the speaker can have better response. Furthermore, since the speaker cover is disposed on the bottom cover instead of being disposed on the keyboard frame, the vibration generated when the speaker emits sound is not directly transmitted to the keyboard frame, such that the keyboard frame is affected by less vibration and is not easy to generate abnormal sound. Moreover, the invention may dispose the vibration absorbing structure between the speaker cover and the bottom cover, so as to utilize the vibration absorbing structure to absorb the vibration generated when the speaker emits sound, thereby further reducing the abnormal sound generated by the notebook computer due to the vibration of the speaker.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A notebook computer comprising:
a base comprising a keyboard frame and a bottom cover, the keyboard frame being disposed on the bottom cover;
a speaker module comprising a speaker cover and a speaker main body, the speaker cover being disposed on the bottom cover to form a resonance chamber between the speaker cover and the bottom cover, the speaker main body being disposed on the speaker cover and located in the resonance chamber; and
a top cover pivotally connected to the base.

2. The notebook computer of claim 1, wherein the speaker cover is adhered to the bottom cover.

3. The notebook computer of claim 1, wherein the speaker module further comprises a vibration absorbing structure disposed between the speaker cover and the bottom cover.

4. The notebook computer of claim 3, wherein the speaker cover is adhered to the vibration absorbing structure and the vibration absorbing structure is adhered to the bottom cover.

5. The notebook computer of claim 3, wherein the vibration absorbing structure is a sponge.

6. The notebook computer of claim 3, wherein the vibration absorbing structure seals a gap between the speaker cover and the bottom cover.

7. The notebook computer of claim 3, wherein the vibration absorbing structure is ring-shaped.

8. The notebook computer of claim 3, wherein the vibration absorbing structure comprises a flange and a side wall, the flange extends from the side wall, a lower edge of the speaker cover abuts against the flange, and an inner wall of the speaker cover abuts against the side wall.

9. The notebook computer of claim 3, wherein the vibration absorbing structure comprises a flange and a side wall, the flange extends from the side wall, a lower edge of the speaker cover abuts against the flange, and an outer wall of the speaker cover abuts against the side wall.

10. The notebook computer of claim 3, wherein the vibration absorbing structure comprises a U-shaped recess and a lower edge of the speaker cover is inserted into the U-shaped recess.
